(19) United States
(12) Patent Application Publication
(10) Pub. No.: US 2006/0003769 A1
(43) Pub. Date: Jan. 5, 2006

(54) Mobile terminal device for handover in WLAN and method thereof

(75) Inventors: Xiaoyu Liu, Yongin-si (KR); Byoung-joon Lee, Seongnam-si (KR); Jin-hyeock Choi, Suwon-si (KR); Kyung-Hun Jang, Suwon-si (KR); Youn-hee Han, Guri-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon -si (KR)

(21) Appl. No.: 11/171,445

(22) Filed: Jul. 1, 2005

(30) Foreign Application Priority Data
Jul. 2, 2004 (KR) 2004-0051512

(51) Int. Cl. H04Q 7/20

(52) U.S. Cl. 455/436

(57) ABSTRACT

A handover method of a mobile terminal device in a wireless local area network (WLAN) includes a mobile terminal device and at least two wireless access points (APs) which communicate with the mobile terminal device using particular radio resources. The mobile terminal device communicates with a wireless AP via a first radio resource, and receives signals from wireless APs via a second radio resource. The mobile terminal device arranges and stores the signals received from the wireless APs in a certain order of size. The mobile terminal device determines an AP for the handover by sequentially searching the stored APs when intensity of the signal received via the first radio resource is smaller than a predetermined value.

### CROSS-REFERENCE TO RELATED APPLICATIONS

This application claims the benefit of 35 U.S.C. § 119(a) of Korean Patent Application No. 2004-51512 filed on Jul. 2, 2004 in the Korean Intellectual Property Office, the disclosure of which is incorporated herein by reference.

### BACKGROUND OF THE INVENTION

1. Field of the Invention

The present invention generally relates to a wireless local area network (WLAN). More particularly, the present invention relates to a mobile terminal device for rapidly performing handover in a wireless local area network (WLAN) and method thereof.

2. Description of the Related Art

A wireless local area network (WLAN) is a data communication system introduced to overcome disadvantages of a wired local area network (LAN) generally used in an office building or a school building. The WLAN utilizing a radio frequency, is able to communicate data through minimal number of links. Accordingly, the WLAN enables a moving user to communicate data with a simple facility, namely, the WLAN enables a mobile network.

The WLAN includes at least one wireless access point (AP) which provides services in a limited geographical area (hereinafter, referred to as a cell). The WLAN should provide a mobile terminal moving from one cell to another with continuity of seamless communications. In order to respond to this requirement, handover takes place in the transition of communications from an AP to another AP. The Institute of Electrical and Electronics Engineers (IEEE) specifies an Inter-Access Point Protocol (IAPP) for the communications and the handover between the APs. The mobile terminal and the APs are required to communicate a plurality of signaling messages with each other for the sake of the handover, which results in delay and greatly affects speech quality. Thus, the need arises for an efficient handover method in a wireless communication environment.

FIG. 1 is a general WLAN environment. Referring to FIG. 1, the WLAN includes a first AP 110, a second AP 112, and a mobile terminal 100 such as a notebook or a personal digital assistant (PDA) wirelessly communicating with the first AP 110. The first AP 110 and the second AP 112 provides the point of interconnection between a wired LAN and a WLAN so that a user can freely utilize services via Internet. The first AP 110 and the second AP 112 covers a communication range of substantially 20˜30 m indoors and substantially 100˜150 m outdoors.

In FIG. 1, the mobile terminal 100 is handed from the first AP 110 to a second AP 112. Typically, it takes about 60 to 200 ms to handover the mobile terminal 100. The handover is executed through scanning to seek a new AP at the mobile terminal 100, authentication and association. The scanning phase is carried out through a passive scanning or an active scanning. In the passive scanning, the mobile terminal 100 changes to one of the channels used in the WLAN system. The mobile terminal 100 determines whether a signal for searching an AP is received by use of the changed channel. The mobile terminal 100 scans the AP using the received signal. If the signal is not received in the changed channel over a predetermined time, the mobile terminal 100 changes to another channel and performs the same procedure.

In active scanning, the mobile terminal 100 requests a response from APs using the selected channel and scans the channel. To be specific, the mobile terminal 100 selects one of a plurality of channels and searches an AP using the selected channel. As compared with passive scanning, the mobile terminal 100 requests a response from the APs using the selected channel. The mobile terminal 100 determines whether the response is received within a preset time (MinChannelTime). Upon receiving the response within the preset time (MinChannelTime), the mobile terminal 100 waits for a preset time (MaxChannelTime) in order to find other APs that use the same channel. When a response to the request is not received for the preset time (MinChannelTime), the mobile terminal 100 selects another channel and performs the same procedure with respect to another channel. Such a scanning phase takes up about 90% of the total time required for the handover.

IEEE 802. 11 standard does not specify that a mobile terminal can connect with two APs at the same time. The mobile terminal has to disconnect from a current AP and search a new AP for the handover. As a result, communications and connections are interrupted for a certain time during the handover.

### SUMMARY OF THE INVENTION

Additional aspects and/or advantages of the invention will be set forth in part in the description which follows and, in part, will be apparent from the description, or may be learned by practice of the invention.

The present invention has been developed in order to solve the problems discussed above and others associated with the conventional arrangement. An aspect of the present invention provides a mobile terminal device and method for reducing handover time in a wireless local area network (WLAN).

Another aspect of the present invention provides a device and method for performing handover without communication interruption in a wireless local area network (WLAN).

Further aspect of the present invention provides a device and method for estimating relative distance between nodes.

To achieve the above aspects of the present invention, there is provided a handover method for a mobile terminal device in a wireless local area network (WLAN) comprising the mobile terminal device and at least two wireless access points (APs) which communicate with the mobile terminal device using particular radio resources. The handover method comprises the steps of sending and receiving a signal to and from the wireless APs over a first radio resource, and receiving signals from the wireless APs over second radio resources in sequence; arranging and storing the signals received from the wireless APs over the second radio resources in a certain order of size; and determining an AP for the handover by sequentially searching the stored APs when intensity of the signal received via the first radio resource is smaller than a predetermined value.

The signals from the wireless APs are received by sequentially searching the particular radio resources used by the wireless APs.

The mobile terminal device operates by changing into an active mode to receive the signals from the wireless APs and a sleep mode to stop the signal reception from the wireless APs in an alternative manner at predetermined time intervals.

The determining of the wireless AP for the handover comprises the sub-step of comparing a reception status of the signals received via the second radio resource with a reception status of the first radio resource, and selecting a wireless AP which uses the second radio resource having the reception status better than the reception status of the first radio resource.

The handover method further comprising the sub-step of determining an AP for the handover among APs not being stored when the AP for the handover is not selected from the stored APs.

The first radio resource is a data channel, and the second radio resource is a control channel.

Consistent with the above aspects of the present invention, a mobile terminal device for communicating with at least two wireless access points (APs) by use of particular radio resources, comprises a first receiver for receiving a signal from a wireless AP via a first radio resource; a second receiver for receiving signals from wireless APs via second radio resources in sequence; a memory for arranging and storing the signals received from the wireless APs over the second radio resources in a certain order of size; a controller for controlling to determine an AP for the handover by sequentially searching the stored APs when intensity of the signal received via the first radio resource is smaller than a predetermined value.

The second receiver changes a frequency of the second radio resources so as to sequentially receive radio resources used by the wireless APs.

The controller controls the second receiver to change into an active mode to receive the signals from the wireless APs and a sleep mode to stop the signal reception from the wireless APs in an alternative manner at predetermined time intervals.

The mobile terminal device further comprises a comparator for comparing a reception status of the first radio resource with a reception status of the second radio resources respectively used by the stored APs, in sequence under the control of the controller.

The controller carries out the handover to a wireless AP using the second radio resource having the reception status better than the reception status of the first radio resource.

The controller determines an AP for the handover among APs not being stored when the AP for the handover is not selected from the stored APs. The first radio resource is a data channel, and the second radio resource is a control channel.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a general wireless local area network (WLAN);

FIG. 2 is a block diagram of a mobile terminal device according to an embodiment of the present invention;

FIG. 3 is operation modes of the mobile terminal device of FIG. 2;

FIG. 4 illustrates the mobile terminal device classifies APs based on intensity of received signals;

FIG. 5 illustrates the mobile terminal device performs a fast search;

FIG. 6 illustrates the mobile terminal device performs the handover according to an embodiment of the present invention.

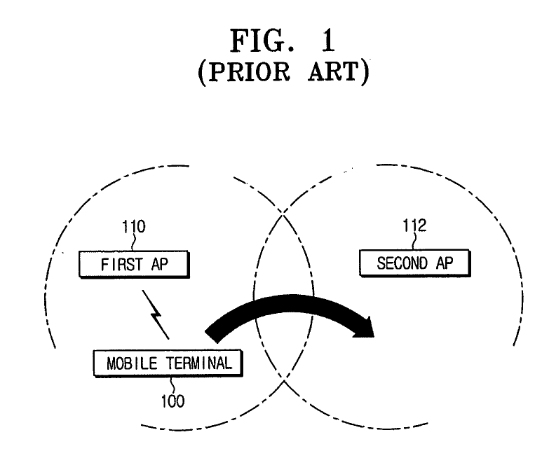

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

According to an embodiment of the present invention, a mobile terminal device includes a first receiver to receive data from a current access point (AP), and a second receiver to receive signals (signals to search an AP) from neighbor APs. Thus, the mobile terminal device transceives only data in the current channel (data channel) and receives a signal to search an AP in a new channel (control channel).

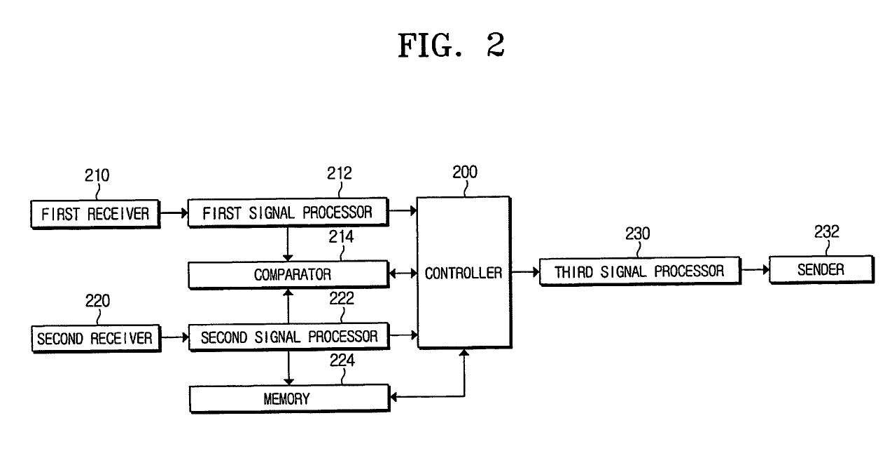

FIG. 2 is a block diagram of the mobile terminal device according to an embodiment of the present invention. In FIG. 2, the mobile terminal device includes a first receiver 210, a second receiver 220, a first signal processors 212, a second signal processor 222, a third signal processor 230, a comparator 214, a memory 224, a controller 200, and a sender 232. It is to be understood that the mobile terminal device can further include other components in addition to the above components.

The first receiver 210 receives data from a current AP in a data channel. The second receiver 220 receives signals to search APs from neighbor APs in a control channel. A conventional mobile terminal device receives data and signals to search APs in the data channel. That is, in order to receive the signals for the AP search, the conventional mobile terminal stops the data reception and receives the signals in the data channel. According to an embodiment of the present invention, the mobile terminal device includes two receivers 210 and 220, and thus receives the data and the signals for the AP search to the respective receivers 210 and 220.

The first signal processor 212 processes the data input from the first receiver 210 and provides the processed data to the controller 200. The second signal processor 222 processes the data input from the second receiver 200 and stores the processed result in the memory 224. The information stored in the memory 224 will be explained below. The second signal processor 222 provides the processed result to the controller 200.

The controller 200 analyzes status of a wireless channel by use of the data provided from the first signal processor 212. If the status of the wireless channel is normal, the controller 200 controls to continuously receive the data from the current AP. If the status of the wireless channel is abnormal, the controller 200 starts to perform a handover procedure. The controller 200 determines a new AP for the handover by means of the information (AP list) stored in the memory 224.

The comparator 214 compares the wireless channel status of the current AP with those of APs stored in the memory 224. If there is any AP having a better channel status than the current AP, information relating to the new AP is transferred to the controller 200.

The third signal processor 230 processes the data (data to be transferred to the new AP) received from the controller 200. The processing of the third signal processor 230 is reverse to that of the first signal processor 212. The sender 232 wirelessly transmits the signal processed at the third signal processor 230.

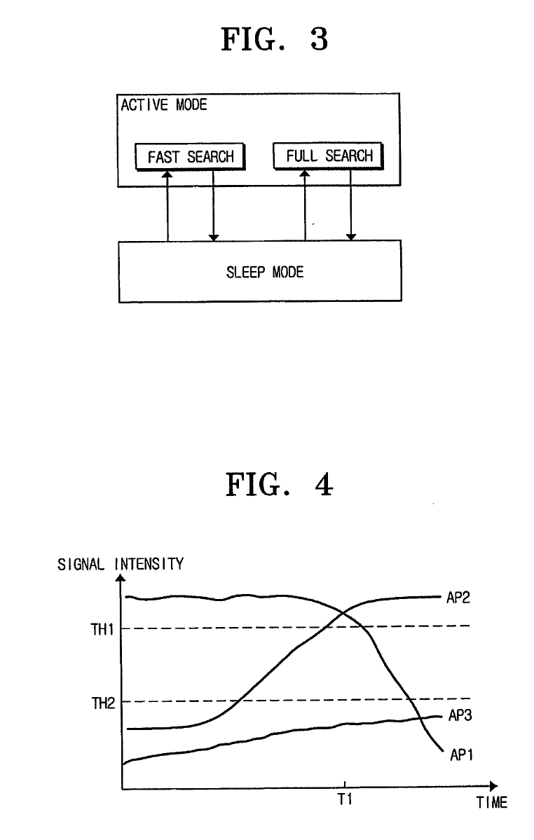

FIG. 3 illustrates operations of the second receiver 220 of the mobile terminal device. The second receiver 200 includes two modes as shown in FIG. 3. That is, the second receiver 200 includes an active mode to scan the neighbor APs and a sleep mode to stop the scanning. The active mode is divided into a fast search mode and a full search mode. The mobile terminal device scans specific APs in the fast search mode, and scans the entire neighbor APs in the full search mode. In FIG. 3, the mobile terminal device changes the mode between the two modes of the active mode and the sleep mode.

The following describes the information stored in the memory 224. The second receiver 220 of the mobile terminal device receives the signal for the AP search from the neighbor APs. The wireless channel status of the neighbor APs are obtained using the received signal, and the neighbor APs are classified depending on their wireless channel status. Generally, the mobile terminal device classifies the neighbor APs into three categories, that is, a candidate AP, a monitored AP and a detected AP. The candidate AP can perform the handover at any time, and the monitored AP is an AP of which signal state is acquired to some extent. The detected AP is an AP of which a signal is only detected. Table 1 shows an example of an AP list stored in the memory 224 of the mobile terminal device.

TABLE 1

| | |
|---|---|
| Candidate AP | AP1, AP3 |
| Monitored AP | AP4 |
| Detected AP | AP5 |

In Table 1, the candidate AP is AP1 and AP3, the monitored AP is AP4, and the detected AP is AP5. The mobile terminal device can allocate priority to the candidate APs based on a certain order, specifically, based on the wireless channel status (intensity of the received signal).

The mobile terminal device updates Table 1 at predetermined time intervals. The mobile terminal device can update Table 1 each time an event occurs such as handover and turn-on of the mobile terminal device. The user can adjust the predetermined time intervals. It is noted that power consumption of the mobile terminal device increases when the predetermined time intervals are set shorter.

Referring back to FIG. 3, the second receiver 220 maintains the sleep mode. The second receiver 220 changes to the active mode at the predetermined time intervals. Generally, the second receiver 220 changes to the full search mode of the active mode. The second receiver 220 scans the neighbor APs in the full search mode and updates Table 1 using the scanning result.

FIG. 4 depicts a criterion for the classification of the neighbor APs, which is stored in the memory 224. Referring to FIG. 4, the user sets a first threshold and a second threshold. As for the signal intensity exceeding the first threshold, the channel status of the candidate AP is indicated. As for the signal intensity below the second threshold, the channel status of the detected AP is indicated. As for the signal intensity between the first threshold and the second threshold, the channel status of the monitored AP is indicated.

The status of the neighbor APs changes as the time passes by as shown in FIG. 4. As the time passes, AP1 changes from the candidate AP to the monitored AP and then the detected AP, and AP2 changes from the detected AP to the monitored AP and then the candidate AP. The AP3 maintains the detected AP. As the second receiver 220 classifies the neighbor APs at T1, AP1 and AP2 becomes the candidate AP and AP3 becomes the detected AP.

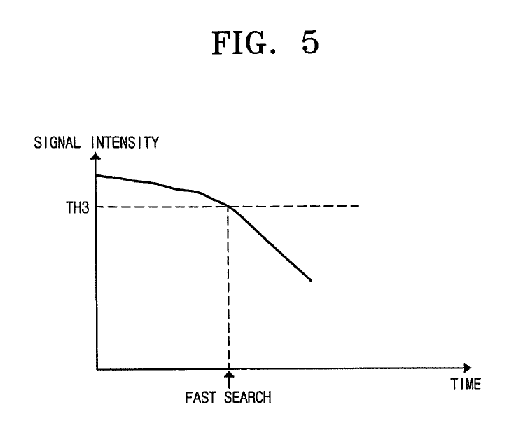

FIG. 5 depicts that the mobile terminal device determines whether to perform the handover. The mobile terminal device analyzes the channel status of the signal received from the first receiver 210. The channel status is obtained using an intensity or a power of the received signal. The mobile terminal device compares the intensity of the received signal with a third threshold. When the signal intensity is below the third threshold, the mobile terminal device performs the handover. The mobile terminal device scans the APs defined in Table 1 without having to scan all of the neighbor APs. In order to reduce the scanning phase, the mobile terminal device may store detailed information relating to the APs. Table 2 shows another example of the information stored in the memory 224.

TABLE 2

| | | |
|---|---|---|
| Candidate AP | AP1 | Channel 2 |
| | AP3 | Channel 4 |
| Monitored AP | AP4 | Channel 3 |
| Detected AP | AP5 | Channel 5 |

Table 2 shows the neighbor APs and information relating to channels used by the neighbor APs. The memory 224 may store the intensity of the signal received from each AP together with the channel information. Thus, the mobile terminal device can reduce the handover time.

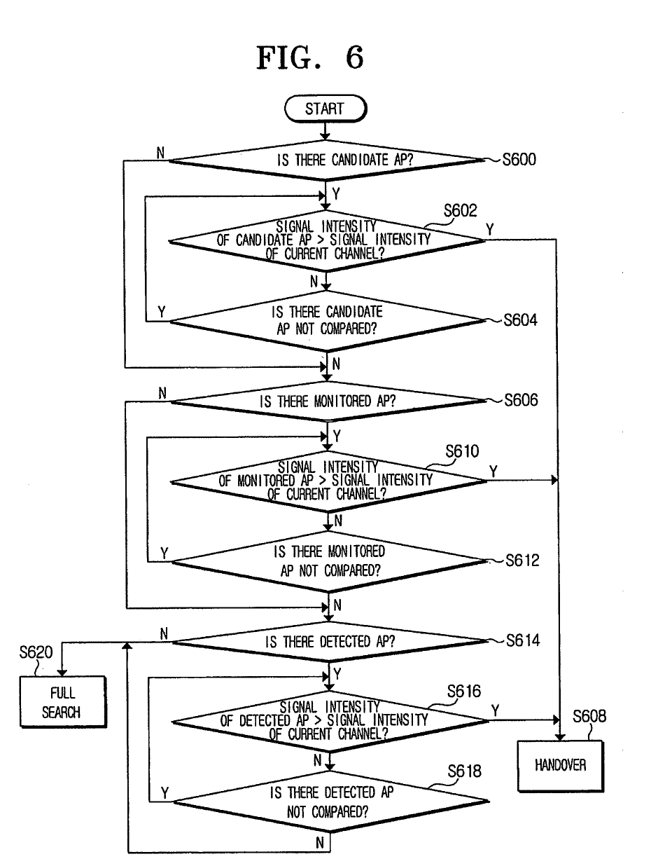

FIG. 6 is a flowchart of a handover operation of the mobile terminal device according to an embodiment of the present invention, to be explained in detail.

The mobile terminal device performs the handover when the intensity of the signal received from the first receiver 210 is below the third threshold. The mobile terminal device determines the presence or absence of a candidate AP in Table 1 stored in the memory 224 (S600). If so, the mobile terminal device proceeds to S602, or if not, the mobile terminal device proceeds to S606. The mobile terminal device compares the signal intensity of the candidate AP (intensity of the signal received from the second receiver 220) with that of the current channel (intensity of the signal received from the first receiver 210) (S602). When the signal intensity of the candidate AP is greater than that of the current channel, the mobile terminal device proceeds to S608. Otherwise, the mobile terminal device proceeds to S604.

It is illustrated that the signal intensity of the candidate AP is compared with that of the current channel (S602) by way of example, but not limited to this comparison. In order to prevent a ping-pong phenomenon, the signal intensity of the candidate AP can be compared with the signal intensity +α.

The mobile terminal device determines whether there is any candidate AP not being compared (S604). If so, the mobile terminal device proceeds to S602, or if not, the mobile terminal device proceeds to S606.

The mobile terminal device determines whether there is a monitored AP in Table 1 stored in the memory 224(S606). If so, the mobile terminal device proceeds to S610, or if not, the mobile terminal device proceeds to S614. The mobile terminal device compares the signal intensity of the monitored AP with that of the current channel (S610). When the signal intensity of the monitored AP is greater than that of the current channel, the mobile terminal device proceeds to S608. When the signal intensity of the monitored AP is not greater than that of the current channel, the mobile terminal device proceeds to S612. To prevent the ping-pong phenomenon, the signal intensity of the monitored AP can be compared with the signal intensity +β of the current channel (S610).

The mobile terminal device determines whether there is any monitored AP not being compared (S612). If so, the mobile terminal device proceeds to S610, or if not, the mobile terminal device proceeds to S614.

The mobile terminal device determines whether there is any detected AP in Table 1 stored in the memory 224 (S614). If so, the mobile terminal device proceeds to S616, or if not, the mobile terminal device proceeds to S620. The mobile terminal device compares the signal intensity of the detected AP with that of the current channel (S616). When the signal intensity of the detected AP is greater than that of the current channel, the mobile terminal device proceeds to S608. When the signal intensity of the detected AP is not greater than that of the current channel, the mobile terminal device proceeds to S618. To prevent the ping-pong phenomenon, the signal intensity of the detected AP can be compared with the signal intensity +δ of the current channel (S616).

The mobile terminal device determines whether there is any detected AP not being compared (S618). If so, the mobile terminal device proceeds to S616, or if not, the mobile terminal device proceeds to S620.

The mobile terminal device performs the handover (S608), and performs the full search (S620). According to an embodiment of the present invention, the fast search is carried out prior to the handover. If an AP for the handover is not found through the fast search, the full search is carried out to discover an AP for the handover.

The mobile terminal device searches the neighbor APs through the full search, and determines an AP for the handover among the searched APs.

In light of the foregoing as explained above, the conventional method performs the handover using only one channel, and thus causes the communication interruption. According to an embodiment of the present invention, an additional channel is used for the handover so that the communication interruption is prevented. Furthermore, an AP is selected from APs allowing the handover and the handover to the selected AP is performed. As a result, the handover time can be reduced.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A handover method of a mobile terminal device in a wireless local area network (WLAN) comprising the mobile terminal device and at least two wireless access points (APs) which communicate with the mobile terminal device using particular radio resources, the handover method comprising:
sending and receiving a signal to and from the wireless APs over a first radio resource, and receiving signals from the wireless APs over second radio resources in sequence;
arranging and storing the signals received from the wireless APs over the second radio resources in a certain order of size; and
determining an AP for the handover by sequentially searching the stored APs when intensity of the signal received via the first radio resource is smaller than a predetermined value.

2. The handover method according to claim 1, wherein the signals from the wireless APs are received by sequentially searching the particular radio resources used by the wireless APs.

3. The handover method according to claim 2, wherein the mobile terminal device operates by changing into an active mode to receive the signals from the wireless APs and a sleep mode to stop the signal reception from the wireless APs in an alternative manner at predetermined time intervals.

4. The handover method according to claim 1, wherein the determining of the wireless AP for the handover comprises the sub-step of comparing a reception status of the signals received via the second radio resource with a reception status of the first radio resource, and selecting a wireless AP which uses the second radio resource having the reception status better than the reception status of the first radio resource.

5. The handover method of claim 4, wherein selecting a wireless AP having the reception status better than the reception status of the first radio resource comprises selecting a wireless AP having a signal intensity +B over the signal intensity of the first radio resource to effect a smooth handover.

6. The handover method according to claim 4, further comprising determining an AP for the handover among APs not being stored when the AP for the handover is not selected from the stored APs.

7. The handover method according to claim 1, wherein the first radio resource is a data channel, and the second radio resources comprise at least one control channel.

8. A mobile terminal device for communicating with at least two wireless access points (APs) by use of particular radio resources, comprising:
a first receiver for receiving a signal from a wireless AP via a first radio resource;
a second receiver for receiving signals from wireless APs via second radio resources in sequence;
a memory for arranging and storing the signals received from the wireless APs over the second radio resources in a certain order of size;
a controller for controlling to determine an AP for the handover by sequentially searching the stored APs when intensity of the signal received via the first radio resource is smaller than a predetermined value.

9. The mobile terminal device according to claim 8, wherein the second receiver changes a frequency of the second radio resources so as to sequentially receive radio resources used by the wireless APs.

10. The mobile terminal device according to claim 8, wherein the controller controls the second receiver to change into an active mode to receive the signals from the wireless APs and a sleep mode to stop the signal reception from the wireless APs in an alternative manner at predetermined time intervals.

11. The mobile terminal device according to claim 8, further comprising a comparator for comparing a reception status of the first radio resource with a reception status of the second radio resources respectively used by the stored APs, in sequence under the control of the controller.

12. The mobile terminal device according to claim 8, wherein the controller carries out the handover to a wireless AP using the second radio resource having the reception status better than the reception status of the first radio resource.

13. The mobile terminal device according to claim 8, wherein the reception status better than the reception status of the first radio resource is a reception status having a signal intensity of +B over the signal intensity of the first radio resource.

14. The mobile terminal device according to claim 8, wherein the controller determines an AP for the handover among APs not being stored when the AP for the handover is not selected from the stored APs.

15. The mobile terminal device according to claim 8, wherein the first radio resource is a data channel, and the second radio resources is a control channel.

16. A handover method for a mobile terminal device in a wireless local area network (WLAN) comprising the mobile terminal device and at least two communicating wireless access points, one of which is a current access point, and one of which is a neighbor access point, further comprising:
sending and receiving signals to and from the current access points on a data channel,
receiving signals from the neighbor wireless access points on a control channel,
arranging and storing the signals received from the neighbor access points in a certain order of size, and selecting a new current access point based on the size of the signal of the new current access point when the size of the current access point signal falls to a lower predetermined value.

17. A mobile terminal device including:
a first receiver to send and receive data from a current access point,
a second receiver to receive signals from neighbor access points, whereby said second receiver receives control signals from neighbor access points to effect a search for a new current access point,
a controller for comparing relative signal intensities of neighbor access points and selecting a new access point having a signal intensity sufficient to effect a smooth handover to the new current access point.
